(19) United States
(12) Patent Application Publication
(10) Pub. No.: US 2013/0056974 A1
(43) Pub. Date: Mar. 7, 2013

(54) Business Form with Wristband Having Multi-Ply Image Area

(71) Applicants: Sanjay K. Jain, Saint Louis, MO (US); Mark Greer, O'Fallon, MO (US)

(72) Inventors: Sanjay K. Jain, Saint Louis, MO (US); Mark Greer, O'Fallon, MO (US)

(73) Assignee: LASER BAND, LLC, Saint Louis, MO (US)

(21) Appl. No.: 13/224,989

(22) Filed: Sep. 2, 2011

(51) Int. Cl. B42D 15/00

(52) U.S. Cl. 283/99

(57) ABSTRACT

A printer processible business form includes a separable wristband formed with a multi-layer, reinforced central panel or imaging area with a pair of straps extending to the sides thereof. The multi-ply wristband may be formed with a single die cut solely in the top ply of a two ply business form which is folded over after having been separated to thereby fashion the multi-ply print or image area. Alternatively, the multi-ply wristband may be formed with a first die cut in the top ply as before, but with a second die cut in a bottom or backer ply to form a backing or reinforcing panel which is adhered to the wristband and when separated thereby forms a multi-ply print area. In another alternative embodiment, the backer panel may be added to the first embodiment so that the panel or image area has three or even four layers of material to provide maximum reinforcement.

### BACKGROUND AND SUMMARY

Printer processible business forms with various configurations of wristbands die cut therein are well known in the art. The assignee of the present invention owns more than a few patents disclosing and claiming such wristband business forms including most particularly U.S. Pat. No. 7,779,569, the disclosure of which is incorporated herein by reference, which discloses and claims a self-laminating wristband die cut into a two ply business form in various embodiments. Two such embodiments are shown in FIGS. 21 and 22 in which an underlying laminate ply is die cut to form a part of the wristband which when separated from the form may be folded over to laminate a print area 302 die cut into a top or face ply. More particularly, the laminate ply has die cuts 330 which form a lamination portion 336 and die cuts 350 which form straps 352 extending to the sides of the lamination portion 336 or panels. A fold line 338 may be provided to separate the two panels and facilitate their being folded over to laminate the print area 302.

These business forms are particularly valuable and useful in the health care field in that a single page containing multiple wristbands and self-adhering labels may be processed at the same time upon admittance, or in-processing, of a patient and then used as needed during the patient's stay. More recently, a unique identifier such as a bar code is imprinted on these bands and labels to ensure consistent and reliable identification of the patient and his associated articles, charts, meds, specimens such as blood samples, etc., and to verify his identity when he is further processed such as by the routine, periodic taking of his temperature, blood pressure, etc. With the self-laminating feature provided in many of the assignee's previously patented and commercially successful designs, the patient's identification data is over-laminated to provide upgraded protection against errors which might be caused by degradation of the wristband and its printed information.

While the self-laminating wristbands sold in the hundreds of millions by the assignee have been very successful, competitors continue to offer cheaper design wristbands and due to the ever increasing focus on cost savings in the health care field, these competitive designs have met with some success. The assignee's self-laminating wristbands typically are comprised of a top face ply of plain paper stock and a somewhat more expensive thin film laminate ply pattern adhered thereto. As such, they are not competitively priced simply due to their cost of materials, presuming the buyer doesn't understand or desire the extra benefit of the laminating feature. The simpler, cheaper designs are typically single layer wristbands which don't use the more expensive thin film laminate, and which can be cheaply made from materials which some would consider inadequate to guard against their failure through tearing, smearing of the printed information, etc. It has also been found that a single layer wristband has a tendency to curl into a circle or torque and not lie flat against the patient's wrist, thereby making locating and then reading the identifying information such as a bar code difficult. While some more durable materials have been used, such as woven fabric, single layer or single ply wristbands still exhibit reduced resiliency and strength.

In its continuing efforts to improve its wristband offerings, the inventors herein have succeeded in designing and developing a business form with a wristband formed by a die cut in a single ply of material but which has a reinforced image area along with single ply straps. By having a reinforced image or print area, relatively inexpensive materials may be used and yet the area which receives perhaps the most handling, the image area, is made extra strong so as to provide better performance than other prior art single ply wristband designs. At the same time, single ply straps are provided which make the wristband more pliable and thus comfortable to a wearer. Still another advantage is that by being reinforced, and hence thicker than the straps, the image area has a tendency to lie flat against the wrist thereby making it easier to locate and read such as with a bar code reader especially as a flatter surface makes reading errors less likely.

The present invention may be provided in any of a number of different preferred embodiments to suit the particular application or user desire. One embodiment comprises a two ply page with a die cut forming a fold over wristband in the top ply only. A bottom ply is preferably provided and is adhered with a pattern adhesive layer to the top ply. The wristband is configured with a pair of panels and a pair of straps extending from the sides of one or both of the panels. The page business form is passed through a printer to apply the desired patient identifying or other information to one of the panels, as is customary, and then the wristband is separated along with adhesive at the appropriate places from the page and then the panels are folded onto themselves so as to complete the wristband. Thus, a wristband is created with essentially a reinforced two ply image area with a pair of single ply straps extending to its sides. The panels are of course folded over so as to not obscure the printed information, in a manner that could be described as “under-laminating” the printed panel. This is to be contrasted with the over-laminating folding of the laminate panels as used in self-laminating wristbands such as those described in the '569 patent mentioned above. These laminate panels are virtually transparent so that they do not obscure the printed patient information. To “laminate” the print area in the present invention would obscure the printed information, so it is a departure from the teaching of these prior “self-laminating” patents.

Alternative preferred embodiments include situating the straps so that they extend to the sides of just one of the panels so that the straps are aligned, or perhaps more preferably to opposing sides of the two different panels so that as the panels are folded over the straps become aligned, and the adhesive is applied to the proper sides of either or both of the strap ends. Yet another alternative is that a backing panel may be die cut into the second ply and adhered to a wristband design having either a single or multiple panel construction so that upon separation the backing panel is there automatically to reinforce the single panel by making it a multi-ply construction. And in yet another alternative, the backing panel feature could be die cut in the backing sheet behind either of the earlier described embodiments having two panels so that when folded over the reinforced image area comprises three plies of material instead of the two provided in the other embodiments. Various wristband designs can be adapted for this construction including a single strap wristband with cinch slot closure and a full length panel wristband having offset adhesive coated tabs.

As the invention comprises a single ply wristband but with a reinforced multi-ply image area, less expensive and perhaps less sturdy materials may be used, depending on the application, and yet provide adequate performance but at a reduced price. Some of these materials could be, for example: simple ordinary paper face stock, thermal imaging paper, Cellophane, styrene, vinyl, acrylic film, acetate, etc. Alternatively, softer materials may be used as well to provide increased comfort such as woven fabrics, synthetic papers, non-woven fabrics, polyethylene films, co-extrusion films, thin foam, etc. The second ply of backing could also be a less expensive material as it is used only to provide the die cut backing panel or otherwise just to cover the adhesive prior to usage. Some examples include: siliconized polyboard, paper or plastic release carriers, etc.

While the principal advantages and features of the present invention have been briefly explained, a more thorough understanding of the invention may be attained by referring to the drawings and the detailed description of the preferred embodiments that follows.

### BRIEF DESCRIPTION OF THE DRAWINGS

FIG. 1 is a top plan view of the wristband/label combination business form with a wristband die cut in the top ply of the upper portion thereof, with the wristband comprising a fold over design to under-laminate the image area after being separated;

FIG. 2 is a top plan view of the wristband business form in a sheetlet, or envelope sized page, with the same design wristband die cut therein as in FIG. 1;

FIG. 3 is a top plan view of the wristband business form in a thermal imaging version, with the same design wristband die cut in a face ply panel adhered to a backing ply panel such that multiple backing ply panels may be provided in a continuous fan fold, roll or the like;

FIG. 4 is a top plan view of the wristband business form in a thermal imaging version, as depicted in FIG. 3, with self-adhering additional labels die cut therein;

FIG. 5 is a top plan view of the wristband business form with multiple wristbands die cut into the face ply having different lengths, a couple of hang tags, and a tear off card,

FIG. 6 is a top plan view of the wristband/label combination business form with an alternate embodiment of the wristband die cut in the top ply of the upper portion thereof, with the wristband comprising a single ply design with a reinforcing panel die cut into the backing ply,

FIG. 7 is a top plan view of the wristband/label combination business form with an alternate embodiment of the wristband die cut in the top ply of the upper portion thereof, with the wristband comprising the same design as shown in FIG. 1 except with the additional reinforcing panel die cut into the backing ply,

FIG. 8 is a top plan view of the wristband/label combination business form with an alternate embodiment of the wristband die cut in the top ply of the upper portion thereof, with the wristband comprising both straps extending to the sides of one image area panel, a fold over reinforcing panel, and a reinforcing panel die cut into the backing ply,

FIG. 9 is a top plan view of the wristband/label combination business form with another alternate embodiment of the wristband die cut in the top ply of the upper portion thereof, with the wristband comprising a pair of panels with a single strap and cinch attachment, and

FIG. 10 is a top plan view of the wristband/label combination business form with another alternate embodiment of the wristband die cut in the top ply of the upper portion thereof, with the wristband comprising an imaging area extending virtually the full length of the wristband and adhesive tabs on opposing ends of different halves of the imaging area.

### DETAILED DESCRIPTION OF THE PREFERRED EMBODIMENTS

The several embodiments of the present invention are depicted in the drawing figures and generally are a departure from the self-laminating wristband designs/inventions disclosed and claimed in the many US patents owned by the assignee hereof. Examples of these self-laminating wristband designs/inventions may be found in several of the more pertinent issued US patents such as U.S. Pat. Nos. 7,779,569 and 7,784,210, the disclosures of which are incorporated herein by reference. As explained above, these two patents disclose and claim good and commercially valuable inventions which essentially comprise a two ply form with the top ply comprising a face stock or paper layer, or thermal paper in the '210 patent, with an underlying transparent laminate film for folding over and laminating the patient data imprinted on the top ply. While these wristband designs/inventions are very popular, some applications (and customers such as hospitals for example) demand a less expensive wristband. As the cost of materials constitutes the principal factor in determining the cost of wristbands, the inventors herein have developed the subject invention which provides many of the advantages of the wristband designs found in these two patents but which may be constructed with different and less expensive materials.

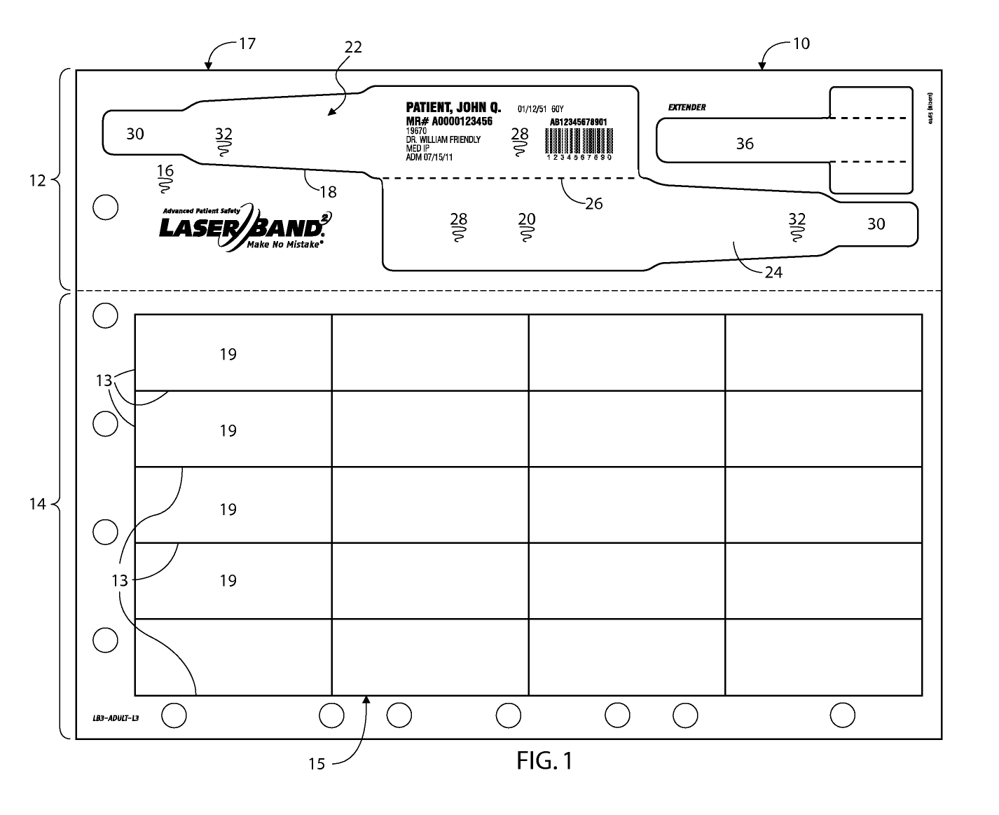

As shown in FIG. 1, the business form invention 10 can take the format of the first embodiment comprising a page having an upper portion 12 and a lower portion 14. The page may be an A4, standard letter, standard legal, oversize, envelope, or other standardized size as known in the art. In addition to the top ply 16 shown in the drawing figures, it would be well understood to those of skill in the art, and as depicted in the two patents mentioned above and incorporated herein by reference, there is a bottom ply 17 which may be a single sheet or multiple sheets should different materials be used for the upper portion 12 and lower portion 14. When different materials are used for the lower portion 14, which has a plurality of die cuts 13 defining a matrix 15 of self-adhering labels 19, a less expensive material is preferably used for the bottom ply 17. The upper portion 12 of the first embodiment 10 has a die cut 18 defining a fold over wristband 20 solely in the top ply 16. It is configured to mimic the overall shape of the wristband shown in FIG. 22 of the '569 patent. However, an important distinction is that the wristband shown in FIG. 22 is comprised of portions of both the top and bottom plies while the wristband 20 shown in FIG. 1 is die cut solely in the top ply 16. More particularly, the wristband 20 is comprised of a top half 22 and a bottom half 24 separated by a line of perforation, or fold line, 26 at the joinder of two panels 28 either one of which can be printed and thus form an image area. As shown in FIG. 1, preferably the top panel 28 and labels 19 are printed with patient data, by first processing the business form 10 through a printer such as a laser printer or thermal printer. Preferably a pattern layer of adhesive joins the top ply 16 and bottom ply 17 including a layer of adhesive applied to each end 30 of the straps 32 extending to the side of each panel 28, but not along their length, so that strap ends 30 may be adhered to each other as the wristband is attached to a user's wrist. When separated, the wristband is folded along the fold line 26 and the panels 28 also have a layer of adhesive so that the panels 28 are adhered to each other, thereby reinforcing them. The panels 28 are folded so that the patient data is not obscured, for obvious reasons. Also, an extender 36 is die cut into the top ply 16 to extend the length of the wristband 20 for patient's having particularly large wrists.

In this first embodiment 10, the top half 22 and bottom half 24 of wristband 20 are substantially the same in overall shape and size, and with the straps 32 extending from opposite sides of different panels 28. With this arrangement, after the wristband 20 is folded over to reinforce the panels 28, the strap ends 30 are situated so that they are opposing to thereby bring both adhesive coated surfaces together when joining them to thereby provide the adhesive strength of two layers of adhesive.

Examples of material that can be preferably used for the top ply 16 are: woven fabrics, synthetic papers, non-woven fabrics, polyethylene films, polypropylene films, co-extrusion films, thin foam, etc. Examples of material that can preferably be used for the bottom ply 17 are: siliconized polyboard, paper or plastic release carriers, etc.

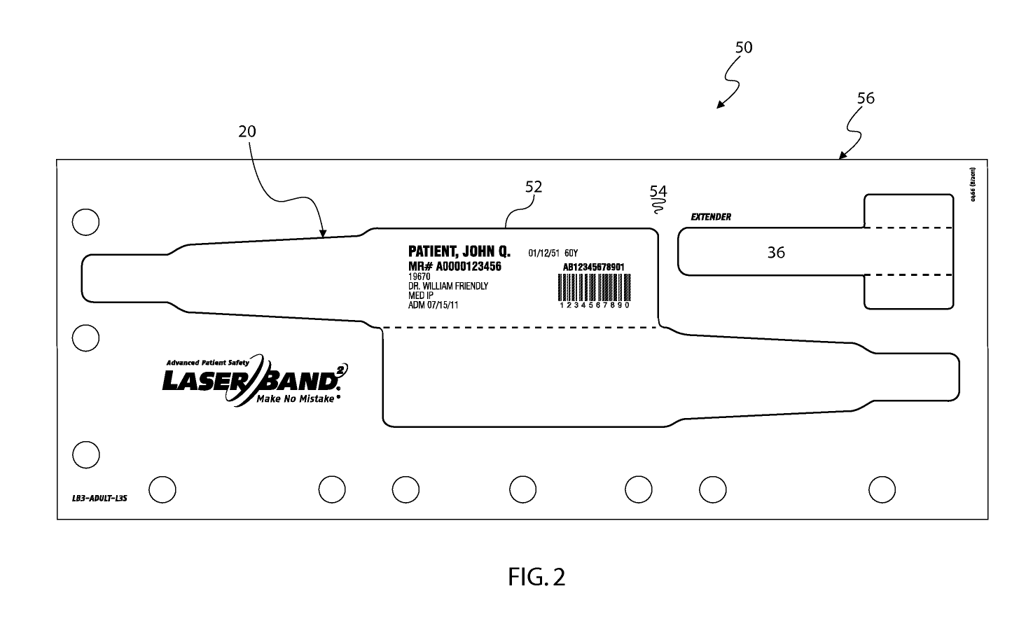

In a second embodiment 50 as depicted in FIG. 2, the same wristband design 20 plus a wristband extender 36 is formed by a plurality of die cuts 52 into the top ply 54 of an envelope or “sheetlet” sized page 56. This embodiment 50 is particularly useful in those applications where labels are not needed such as for a replacement wristband damaged or lost during use.

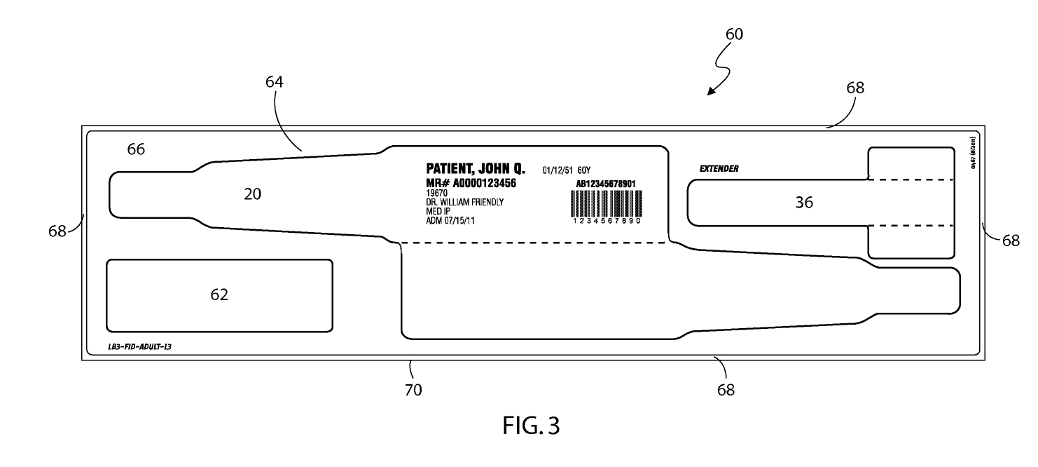

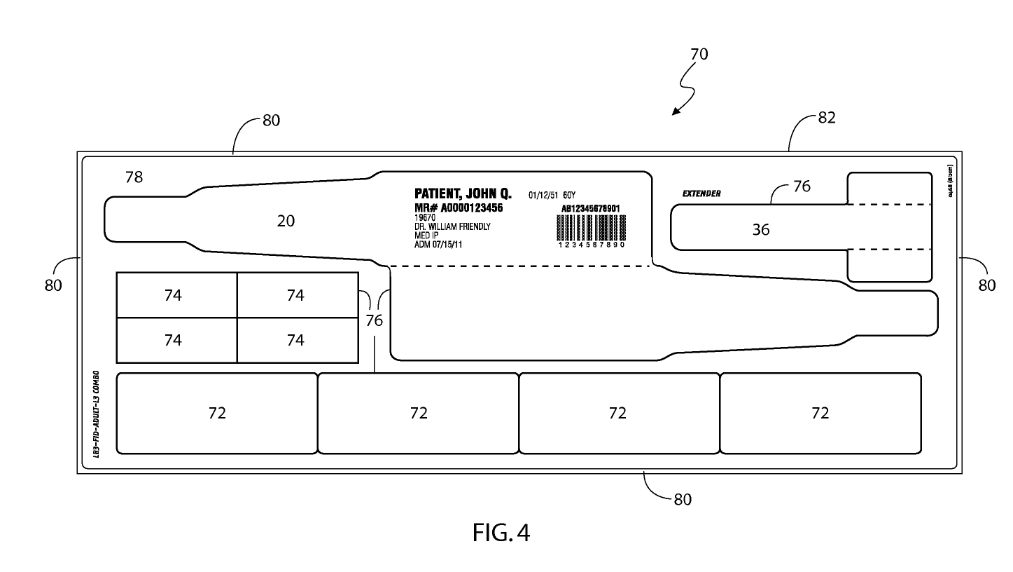

In another embodiment 60 as depicted in FIG. 3, the same wristband design 20 plus a wristband extender 36 and a label 62 is formed by a plurality of die cuts 64 into a top ply 66 which has a margin 68 around its periphery such that the top or face ply 66 essentially forms a “patch” adhered to an underlying carrier or bottom ply 70. In this embodiment 60, the top ply 66 is preferably made of a material that is receptive to a thermal printing process, and additional carriers 70 are preferably connected into a fan fold or roll for installation into a typical thermal printer. A variation of the embodiment 60 is shown also as a thermal print version 70 in FIG. 4. This thermal print version 70 also has the same wristband design 20 plus a wristband extender 36 but also includes four self-adhering labels 72 and four special precautions labels 74 formed by a plurality of die cuts 76 into the top ply 78. The top ply 78 similarly has a margin 80 around its periphery such that it forms a patch adhered to the underlying carrier 82 which is typically replicated into a continuous fan fold or roll.

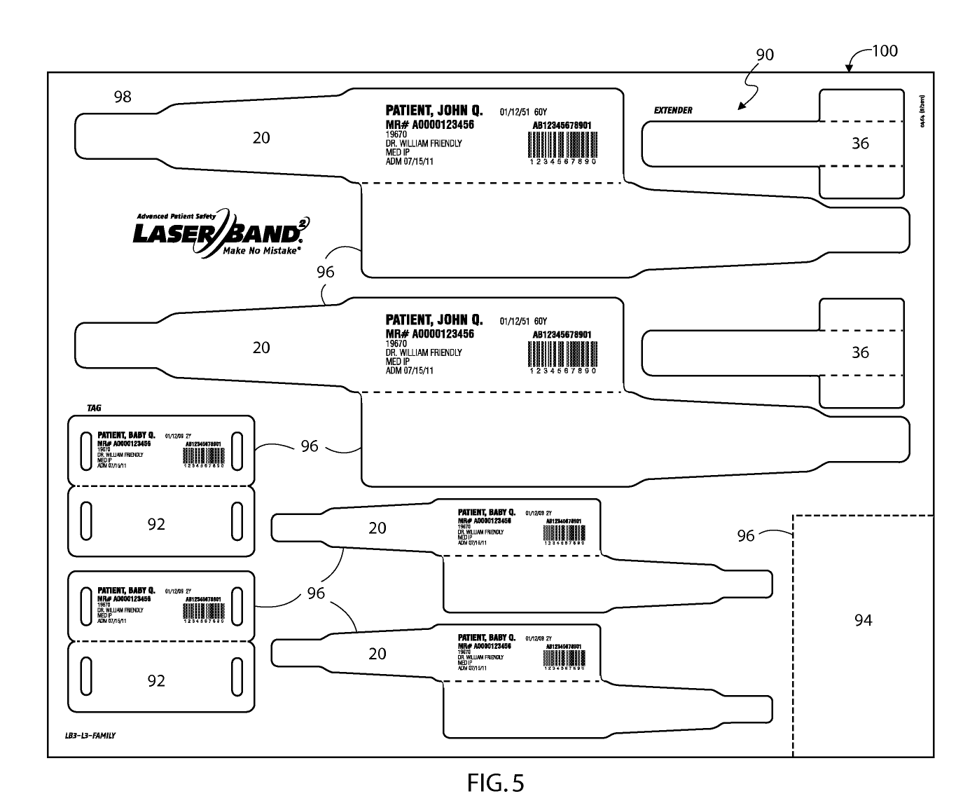

In yet another embodiment 90 as depicted in FIG. 5, again the same wristband design 20 plus a pair of wristband extenders 36, a couple of fold over, multi-ply hang tags 92 and a tear off card 94 are defined by a plurality of die cuts 96 into a top ply 98, except that the die cut 96 forming the tear off card extends all the way through both the top ply 98 and bottom ply 100 so that it may be separated intact from both plies 98, 100. This embodiment is preferably referred to as the “mother/father/baby” version as it includes two adult size wristbands and two infant size wristbands as would be suited for a couple experiencing a child birth at a hospital.

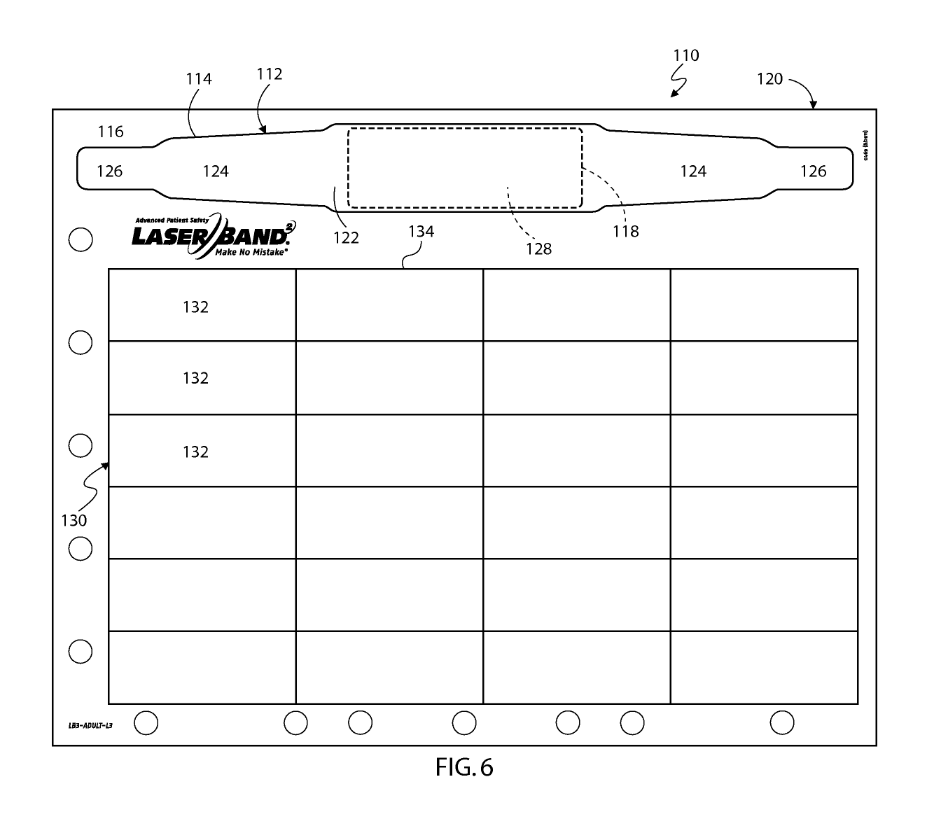

In still another embodiment 110 as depicted in FIG. 6, a different wristband 112 is shown. Wristband 112 is formed from a first die cut 114 in the top ply 116 and a second die cut 118 in the bottom or backing ply 120. The first die cut 114 defines an outline of the wristband which includes a single width rectangular panel 122 on which the patient's data is printed, and a pair of straps 124 extending to the sides thereof. The strap ends 126 may be provided each with a layer of adhesive, or just one end with a layer of adhesive, for securing the wristband to a user. The second die cut 118 defines a reinforcing or backing panel 128 which is adhered to the panel 122 with a layer of adhesive so that when the wristband is removed from the form 110, the backing panel 126 separates along its die cut 118 to thereby provide a wristband with a multi-ply reinforced image or print area. It should be understood that this wristband design 112 can be provided in any other of the other embodiments described herein. This business form 110 also includes a matrix 130 of self-adhering labels 132 as defined by another die cut 134 in the top ply 116.

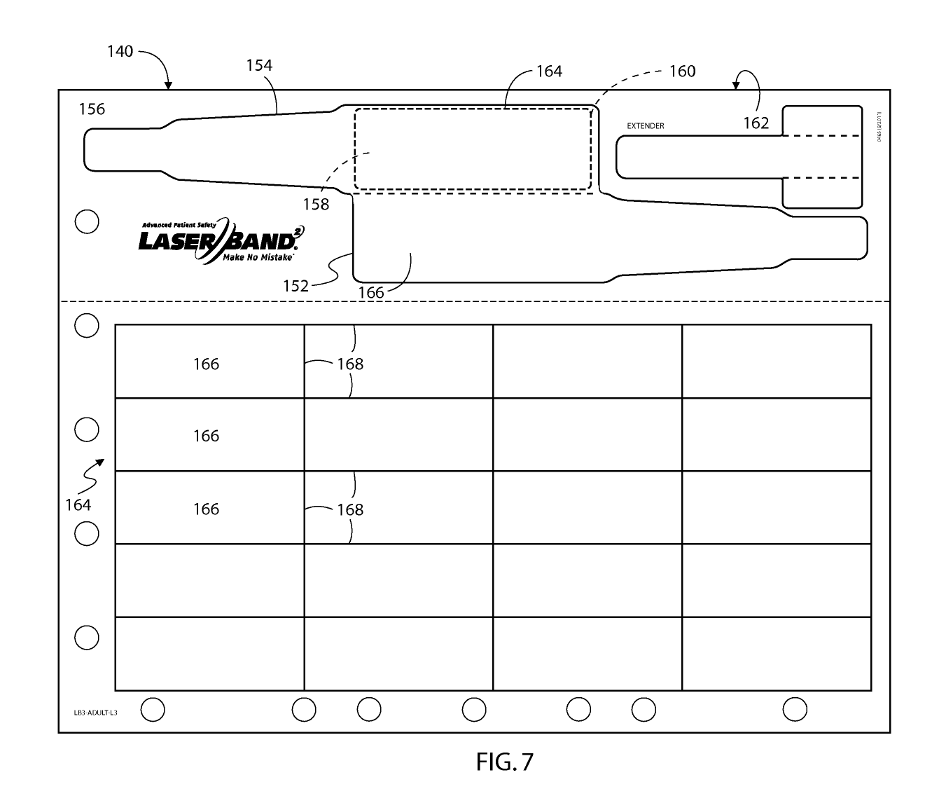

Yet another embodiment 140 as depicted in FIG. 7 discloses another different wristband 152. Wristband 152 is formed from a first die cut 154 in the top ply 156, similarly to the first wristband 20, but also includes a reinforcing or backing panel 158 formed by a second die cut 160 formed in the bottom ply 162 adhered to the panel portion 164 of wristband 152. In essence, this wristband design is a combination of the first embodiment wristband 20 with the backing panel 126 from the wristband embodiment shown in FIG. 6. Thus, wristband 152 has three layers of material instead of the two layers of material reinforcing the wristband print areas of the other embodiments. Although backing panel 158 is depicted as being formed behind the top panel portion 164, it could also be formed behind the bottom panel portion 166 of wristband 152. When separated and folded over, the backing panel is thereby sandwiched between wristband panels 164 and 166, and adhered to each of them with adhesive provided behind each of the panels 164, 166. As with the wristband embodiment shown in FIG. 6, the wristband design depicted in this FIG. 7 may be provided in the other embodiments as well. To complete this business form 150, a matrix 164 of self-adhering labels 166 are defined by a die cut 168 in the top ply 156.

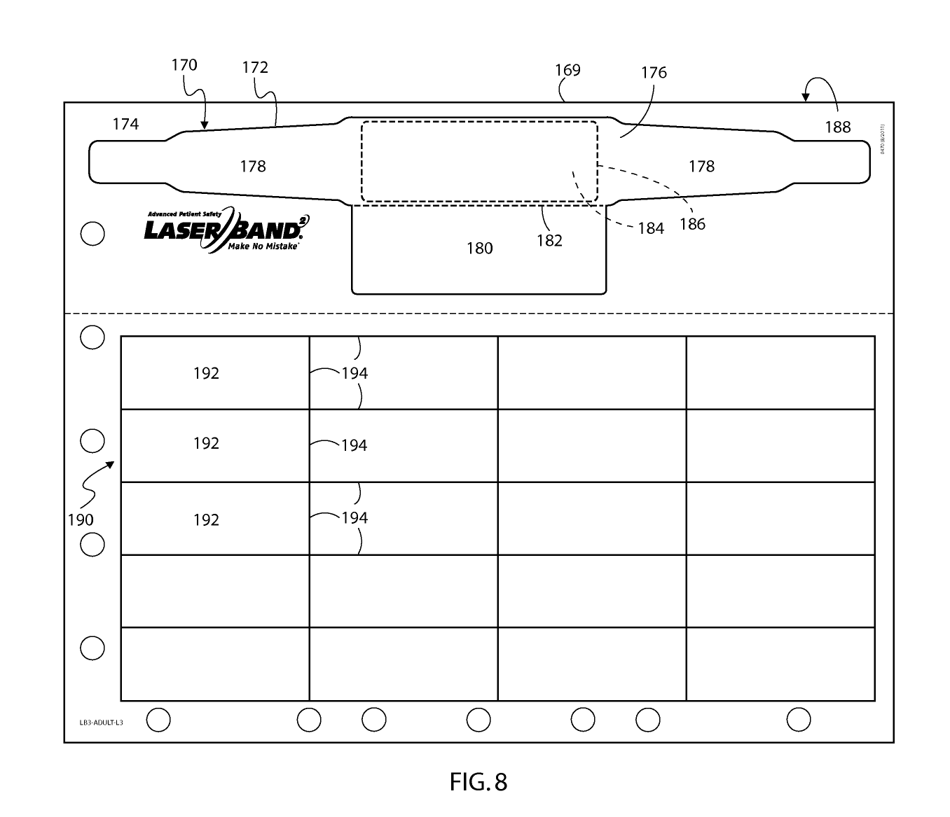

A business form 169 which is a variation of the embodiment 140 is shown in FIG. 8, and includes a somewhat different wristband design 170. Wristband 170 is defined by a die cut 172 in top ply 174 and includes a top panel 176 having a pair of straps 178 extending to each of its sides, with a second panel 180 being joined to the first panel 176 with a perforated or fold line 182 therebetween. A backing panel 184 is defined by another die cut 186 in the bottom ply 188 and adhered to the top panel 176 so that as the wristband 170 is separated from the form 169 the backing panel 184 remains adhered thereto, thereby reinforcing top panel 176. Additionally, after separation, the wristband 170 is folded about fold line 182 to adhere and sandwich the backing panel 184 between the two wristband panels 176, 180. As with the wristband embodiment shown in FIGS. 6 & 7, the wristband design depicted in this FIG. 8 may be provided in the other embodiments as well. To complete this business form 169, a matrix 190 of self-adhering labels 192 are defined by a die cut 194 in the top ply 174.

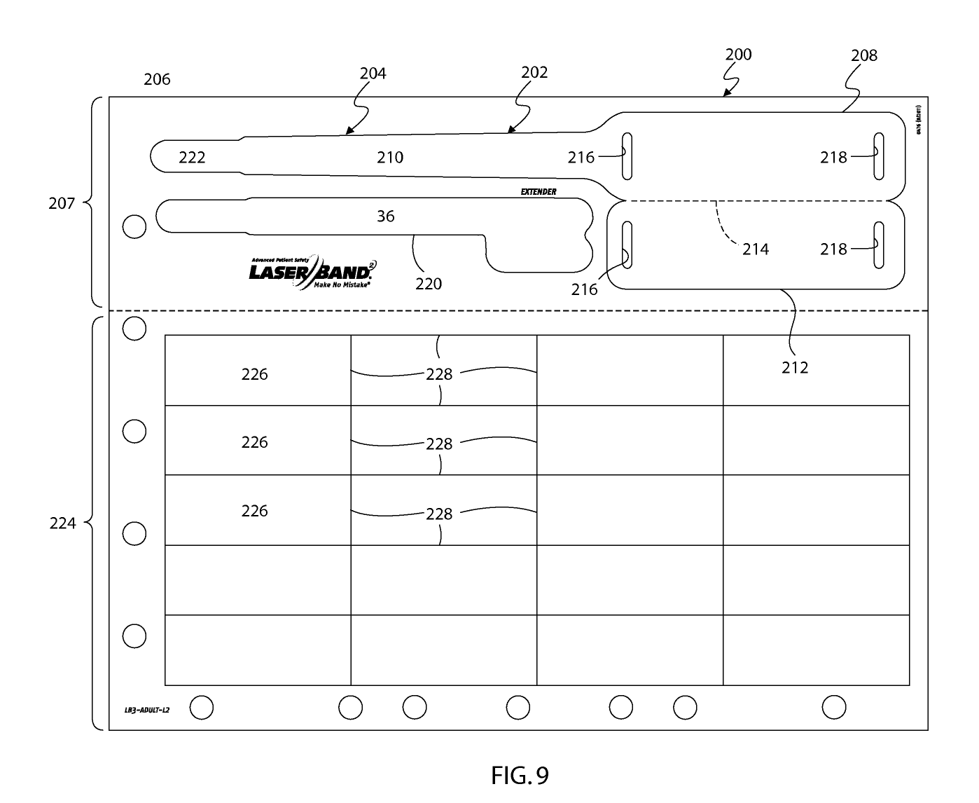

Yet another wristband/label business form 200 is shown in FIG. 9, and includes a different wristband design 202 formed by a die cut 204 in the top ply 206 of upper portion 207. Wristband 202 includes a top, substantially rectangular panel 208 with a strap 210 extending from a side thereof, a bottom, substantially rectangular panel 212 with a perforated fold line 214 therebetween, with two pairs of cinch slots 216, 218 at opposite ends of the panels 208, 212. Although two pairs of cinch slots 216, 218 are shown, either pair could be provided and preferably pair 218 would be most commonly used. A wristband extender 36 is also formed by a die cut 220 in top ply 206. Preferably, the bottom panel 212 forms the image area so that when the wristband 202 is separated from the form 200 and folded over to adhere the panels 208, 212, the adhesive applied to the underneath of the strap end 222 is conveniently situated to facilitate the wristband's attachment by bringing the strap end 222 up through cinch slots 218 (which are then overlapped and adhered into a single slot) and then bending it back over the top of the strap 210 to adhere it thereto. Should it be desired to use the other pair of cinch slots 216 in order to create a hang tag wristband, then preferably the top panel 208 forms the image area to receive the patient data so that the strap end 222 adhesive is situated for adhering to the strap 210. As with other embodiments, this business form 200 includes a matrix 224 of self-adhering labels 226 defined by die cuts 228 in the top ply 206. This business form 200 could also include a backing panel to reinforce either or both of panels 208, 212, as shown and described in the other embodiments, above.

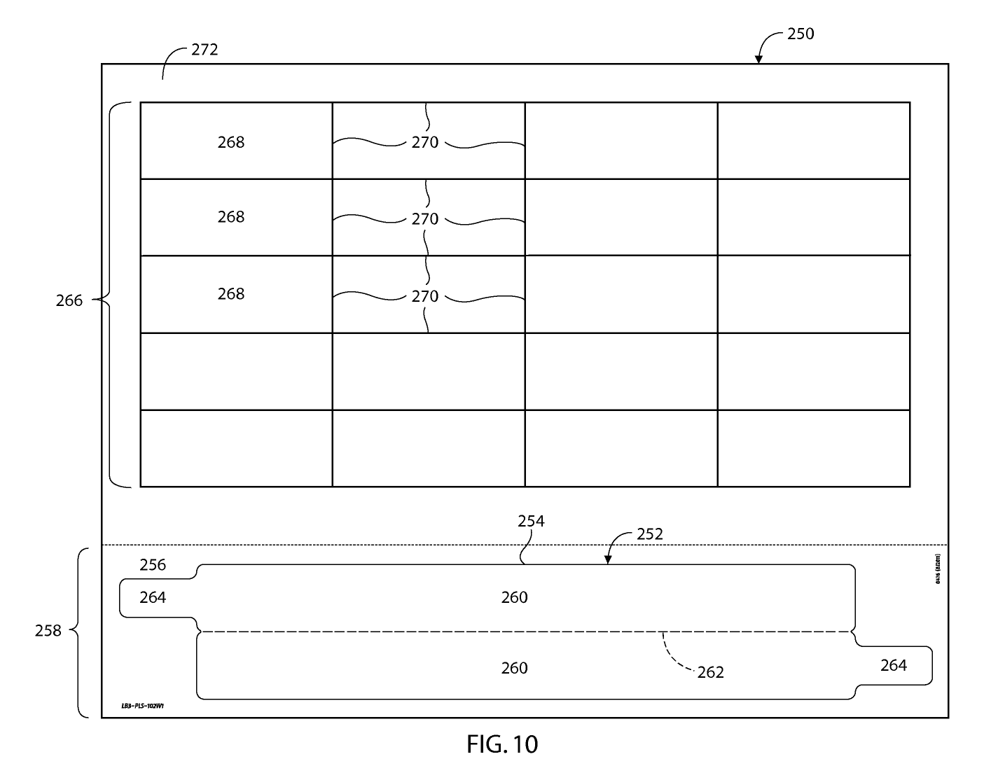

A final embodiment of the business form 250 is depicted in FIG. 10 and includes a wristband 252 formed by a die cut 254 in the top ply 256 of the bottom portion 258 of the form 250. Wristband 252 includes a pair of virtually full length panels 260 separated by a perforation or fold line 262 with a pair of adhesive coated tabs 264 extending from the opposite sides of the panels 260 so that when separated and folded over, the adhesive coated tabs 264 are situated to adhere to each other or to the back of a panel 260 to thereby attach the wristband 252 to a patient. In this embodiment 250, either panel may be imprinted with patient data as the wristband may be folded and then turned in either direction to face the printed data to the outside when wrapped around the wrist. As with other embodiments, this business form 250 includes a matrix 266 of self-adhering labels 268 defined by die cuts 270 in the top ply 256, but with this embodiment in the upper portion 272 of the form 250. This business form 250 could also include a backing panel to reinforce either or both of panels 260, as shown and described in the other embodiments, above.

While the principal advantages and features of the invention have been shown in the drawings and described above, there are various changes that would be apparent to those of skill in the art and it is intended that these be included as part of the invention which should be limited solely by the claims appended hereto and their equivalents. For example, a number of embodiments are depicted with or without a matrix of self-adhering labels and/or with one or more wristbands. It would be understood by one of skill in the art that wristbands and labels could be mixed and matched to suit any particular application or user need.

What is claimed is:

1. A printer processible business form comprising a page with at least one wristband defined by a die cut solely in a single ply thereof, said single ply being suitable for receiving and retaining a printed image, said wristband including a pair of substantially rectangular panels and at least one strap with no more than one strap extending from the side of any panel, at least one of said panels comprising an image receiving area, and configured so that when the wristband is separated from the page the panels may be overlapped and adhered so as to form a multi-ply image receiving area.

2. The business form of claim 1 wherein said pair of panels are substantially the same size and are aligned to overlap upon separation from said page.

3. The business form of claim 2 wherein said at least one strap comprises a strap extending to opposing sides of both of said panels.

4. The business form of claim 3 wherein said straps are die cut to extend from different panels.

5. The business form of claim 4 wherein said straps are further configured to be brought into substantial alignment with each other upon separation from the business form and overlapping of the panels.

6. The business form of claim 1 wherein said wristband includes only one strap and further comprising at least one pair of cinch slots in said panels.

7. The business form of claim 1 wherein said single ply is made of a woven fabric material.

8. The business form of claim 1 wherein said single ply is made of a synthetic paper material.

9. The business form of claim 1 wherein said page is any one taken from a group comprising: A4, letter size, legal size, envelope size, or other standarized size.

10. The business form of claim 1 further comprising a second backing ply adhered to said single ply with a patterned adhesive layer, said page being thereby comprised of only two adhered plies.

11. The business form of claim 10 further comprising a backing panel formed by a die cut in said backing ply, said backing panel being substantially aligned with and adhered to at least one of said panels in said single ply.

12. A printer processible business form comprising a page with at least one wristband defined by a die cut in a top ply thereof, said wristband having a pair of offset straps and configured to form a multi-ply print area when separated from the page.

13. The business form of claim 12 wherein said multi-ply print area comprises a pair of panels, said panels being configured to overlap and adhere to each other when the wristband is separated from the page and folded over, and wherein said straps extend from the sides of said panels.

14. The business form of claim 12 further comprising a backing ply adhered to said single ply with a layer of patterned adhesive.

15. The business form of claim 14 further comprising a die cut in said backing ply defining a backing panel adhered to and underlying the print area to thereby remain adhered thereto when the wristband is separated from the page, the backing panel thereby forming a second ply of the multi-ply print area.

16. The business form of claim 13 wherein said panels extend substantially the entire length of said wristband, and further comprising a pair of adhesive layered tabs at the ends of the panels.

17. The business form of claim 12 further comprising a plurality of die cuts forming a matrix of self-adhering labels.

18. The business form of claim 12 wherein said page is any one taken from a group comprising: A4, letter size, legal size, envelope size, or other standarized size

19. A printer processible business form comprising a page with at least one wristband defined by a die cut in two plies thereof, neither of said plies comprising a laminating ply, said die cut defining a wristband print area comprising a single width, substantially rectangular panel, and said wristband having at least one strap and configured to form a multi-ply print area when separated from the page.

20. The business form of claim 19 wherein said die cut forms said print area in a top ply and a second, backing panel underlying said print area in a bottom ply, said print area and said backing panel being adhered to each other so that they remain adhered to each other upon separation of said wristband from said business form.

21. The business form of claim 20 wherein said die cut forms a pair of straps extending to the sides of the print area in the top ply, and further comprising a layer of adhesive applied to at least one end of one of said straps.

22. The business form of claim 19 wherein said wristband is formed immediately upon separation from said business form, with no folding required.

23. A printer processible business form comprising a page with at least one wristband defined by a die cut in two plies thereof, said die cut defining a wristband print area having at least one strap solely in a top ply, and said wristband being configured to form a multi-ply print area when separated from the page.

24. The business form of claim 23 wherein neither of said plies comprises a laminating ply.

25. The business form of claim 24 wherein said die cut forms a pair of straps extending to the sides of the print area in the top ply, and further comprising a layer of adhesive applied to at least one end of one of said straps.
